(19) United States
(12) Patent Application Publication
(10) Pub. No.: US 2006/0128870 A1
(43) Pub. Date: Jun. 15, 2006

(54) FILLED POLYMER COMPOSITES

(76) Inventors: Ryan E. Marx, Rosemount, MN (US); John W. Longabach, Woodbury, MN (US); James M. Nelson, Woodbury, MN (US); Terri A. Shefelbine, St. Paul, MN (US)

Correspondence Address: 3M INNOVATIVE PROPERTIES COMPANY, PO BOX 33427, ST. PAUL, MN, 55133-3427, US

(21) Appl. No.: 11/275,090

(22) Filed: Dec. 9, 2005

Related U.S. Application Data
(60) Provisional application No. 60/634,925, filed on Dec. 10, 2004.

(51) Int. Cl. C08L 53/00; C08K 3/34

(52) U.S. Cl. 524/505; 524/520; 524/425; 524/442

(57) ABSTRACT

Provided are compositions comprising a polymeric matrix; a plurality of fillers; and a block copolymer wherein at least one segment of the block copolymer interacts with the fillers. Also provided are composition comprising a plurality of fillers having surfaces and a block copolymer wherein at least one segment of the block copolymer is capable of interacting with the fillers upon application in a polymeric matrix. Compositions comprising a flame retardant compound and a block copolymer wherein at least one segment of the block copolymer is capable of interacting with the flame retardant compound upon application in a polymeric matrix are also provided.

### CROSS REFERENCE TO RELATED APPLICATION

This application claims the benefit of U.S. Provisional Application No. 60/634925, entitled “FILLED POLYMER COMPOSITES”, filed on Dec. 10, 2004, the entire contents of which are incorporated herein by reference.

### BACKGROUND

In general, fillers are often added to polymeric composites to either replace costly polymer components, to enhance specific mechanical characteristics of the overall composites, or both. The enhancements provided by the inclusion of the fillers are typically intended to address strength to weight or tensile properties of the composites. Typically large amounts of fillers are needed to impact such properties. However, the inclusion of high levels of fillers while enhancing at least one mechanical characteristic of the composite, may often adversely affect other mechanical characteristics.

### SUMMARY

The present invention is directed to the use of block copolymers as additives for polymeric composites containing fillers. The utilization of block copolymers in conjunction with fillers augments physical properties in the filled composite. The combination of block copolymers with fillers in a polymeric composite may enhance certain mechanical properties of the composite, such as tensile strength, impact resistance, and modulus, over the initial levels achieved by high levels of filler without incorporating block copolymers.

The composition of the present invention comprises a polymeric matrix, one or more fillers and one or more block copolymers. The block copolymers have at least one segment that is capable of interacting with the fillers. For purposes of the invention, the interaction between the block copolymers and the fillers is generally recognized as the formation of a bond through either covalent bonding, hydrogen bonding, dipole bonding, ionic bonding, or combinations thereof. The interaction involving at least one segment of the block copolymer and the filler is capable of enhancing or restoring mechanical properties of the polymeric matrix to desirable levels in comparison to polymeric matrices without the block copolymer.

The present invention is also directed to a method of forming a polymeric matrix containing fillers and one or more block copolymers. The one or more block copolymers are capable of interacting with the fillers. The combination of block copolymers with fillers has applicability in either thermoplastic, elastomeric or thermosetting compositions. The fillers useful in the inventive composition include all conventional fillers suitable for use in a polymeric matrix.

Block copolymers can be tailored for each polymeric matrix, a specific filler, multiple fillers, or combinations thereof, thus adding a broad range of flexibility. In addition, various physical properties can be augmented through block design. Block copolymers can be used instead of surface treatments. Alternatively, the block copolymers may be used in tandem with surface treatments.

### DEFINITIONS

For purposes of the present invention, the following terms used in this application are defined as follows:

“block” refers to a portion of a block copolymer, comprising many monomeric units, that has at least one feature which is not present in the adjacent blocks;

“compatible mixture” refers to a material capable of forming a dispersion in a continuous matrix of a second material, or capable of forming a co-continuous polymer dispersion of both materials;

“interaction between the block copolymers and the fillers” refers to the formation of a bond through either covalent bonding, hydrogen bonding, dipole bonding, ionic bonding or combinations thereof,

“Block copolymer” means a polymer having at least two compositionally discrete segments, e.g. a di-block copolymer, a tri-block copolymer, a random block copolymer, a graft-block copolymer, a star-branched block copolymer or a hyper-branched block copolymer;

“Random block copolymer” means a copolymer having at least two distinct blocks wherein at least one block comprises a random arrangement of at least two types of monomer units;

“Di-block copolymers or Tri-block copolymers” means a polymer in which all the neighboring monomer units (except at the transition point) are of the same identity, e.g., -AB is a di-block copolymer comprised of an A block and a B block that are compositionally different and ABC is a tri-block copolymer comprised of A, B, and C blocks, each compositionally different;

“Graft-block copolymer” means a polymer consisting of a side-chain polymers grafted onto a main chain. The side chain polymer can be any polymer different in composition from the main chain copolymer;

“Star-branched block copolymer” or “Hyper-branched block copolymer” means a polymer consisting of several linear block chains linked together at one end of each chain by a single branch or junction point, also known as a radial block copolymer;

“End functionalized” means a polymer chain terminated with a functional group on at least one chain end; and

“Polymeric matrix” means any resinous phase of a reinforced plastic material in which the additives of a composite are embedded.

### DETAILED DESCRIPTION

The polymeric matrix includes one or more types of fillers, and one or more block copolymers in a compatible mixture. The block copolymers have at least one segment that is capable of interacting with the fillers in the compatible mixture. The interaction involving at least one segment of the block copolymer and the filler is capable of enhancing or restoring mechanical properties of the polymeric matrix to desirable levels in comparison to polymeric matrices without the block copolymer.

### Polymeric Matrix

The polymeric matrix may, in some instances, include any thermoplastic or thermosetting polymer or copolymer upon which a block copolymer and one or more types of fillers may be employed. The polymeric matrix includes both hydrocarbon and non-hydrocarbon polymers. Examples of useful polymeric matrices include, but are not limited to, polyamides, polyimides, polyurethanes, polyolefins, polystyrenes, polyesters, polycarbonates, polyketones, polyureas, polyvinyl resins, polyacrylates and polymethylacrylates.

One preferred application involves melt-processable polymers where the constituents are dispersed in a melt mixing stage prior to forming an extruded or molded polymer article.

For purposes of the invention, melt processable compositions are those that are capable of being processed while at least a portion of the composition is in a molten state.

Conventionally recognized melt processing methods and equipment may be employed in processing the compositions of the present invention. Non-limiting examples of melt processing practices include extrusion, injection molding, batch mixing, and rotomolding.

Preferred polymeric matrices include polyolefins (e.g., high density polyethylene (HDPE), low density polyethylene (LDPE), linear low density polyethylene (LLDPE), polypropylene (PP)), polyolefin copolymers (e.g., ethylene-butene, ethylene-octene, ethylene vinyl alcohol), polystyrenes, polystyrene copolymers (e.g., high impact polystyrene, acrylonitrile butadiene styrene copolymer), polyacrylates, polymethacrylates, polyesters, polyvinylchloride (PVC), fluoropolymers, liquid crystal polymers, polyamides, polyether imides, polyphenylene sulfides, polysulfones, polyacetals, polycarbonates, polyphenylene oxides, polyurethanes, thermoplastic elastomers, epoxies, alkyds, melamines, phenolics, ureas, vinyl esters, or combinations thereof.

The polymeric matrix is included in a melt processable composition in amounts typically greater than about 30% by weight. Those skilled in the art recognize that the amount of polymeric matrix will vary depending upon, for example, the type of polymer, the type of block copolymer, the type of filler, the processing equipment, processing conditions and the desired end product.

Useful polymeric matrices include various polymers and blends thereof containing conventional additives such as antioxidants, light stabilizers, antiblocking agents, and pigments. The polymeric matrix may be incorporated into the melt processable composition in the form of powders, pellets, granules, or in any other extrudable form.

Another preferred polymeric matrix includes pressure sensitive adhesives (PSA). These types of materials are well suited for applications involving fillers in conjunction with block copolymers. Polymeric matrices suitable for use in PSA's are generally recognized by those of skill in the art. Additionally, conventional additives with PSA's, such as tackifiers, fillers, plasticizers, pigments, fibers, toughening agents, fire retardants, and antioxidants, may also be included in the mixture.

Elastomers are another subset of polymers suitable for use as a polymeric matrix. Useful elastomeric polymeric resins (i.e., elastomers) include thermoplastic and thermoset elastomeric polymeric resins, for example, polybutadiene, polyisobutylene, ethylene-propylene copolymers, ethylene-propylene-diene terpolymers, sulfonated ethylene-propylene-diene terpolymers, polychloroprene, poly(2,3-dimethylbutadiene), poly(butadiene-co-pentadiene), chlorosulfonated polyethylenes, polysulfide elastomers, silicone elastomers, poly(butadiene-co-nitrile), hydrogenated nitrile-butadiene copolymers, acrylic elastomers, ethylene-acrylate copolymers.

Useful thermoplastic elastomeric polymer resins include block copolymers, made up of blocks of glassy or crystalline blocks. For purposes of the invention, block copolymers suitable as polymeric matrices are those that are incapable of interaction with the filler. Non-limiting examples include polystyrene, poly(vinyltoluene), poly(t-butylstyrene), and polyester, and the elastomeric blocks such as polybutadiene, polyisoprene, ethylene-propylene copolymers, and ethylene-butylene copolymers. Additionally, polyether ester block copolymers and the like as may be used. For example, poly(styrene-butadiene-styrene) block copolymers (available as “KRATON” Shell Chemical Company, Houston, Tex.). Copolymers and/or mixtures of these aforementioned elastomeric polymeric resins can also be used.

Useful polymeric matrices may also be fluoropolymers. Useful fluoropolymers include, for example, those that are preparable (e.g., by free-radical polymerization) from monomers comprising 2,5-chlorotrifluoroethylene, 2-chloropentafluoropropene, 3-chloropentafluoropropene, vinylidene fluoride, trifluoroethylene, tetrafluoroethylene, 1-hydropentafluoropropene, 2-hydropentafluoropropene, 1,1-dichlorofluoroethylene, dichlorodifluoroethylene, hexafluoropropylene, vinyl fluoride, a perfluorinated vinyl ether (e.g., a perfluoro(alkoxy vinyl) ether such as CF₃OCF₂CF₂CF₂OCF═CF₂, or a perfluoro(alkyl vinyl) ether such as perfluoro(methyl vinyl) ether or perfluoro(propyl vinyl ether)), cure site monomers such as for example, nitrile containing monomers (e.g., CF₂═CFO(CF₂)LCN, CF₂═CFO[CF₂CF(CF₃)O]_{q}(CF₂O)_{y}CF(CF₃)CN, CF₂═CF[OCF₂CF(CF₃)]ᵣO(CF₂)ₜCN, or CF₂═CFO(CF₂)ᵤOCF(CF₃)CN where L=2-12; q=0-4; r=1-2; y=0-6; t=1-4; and u=2-6), bromine and/or containing monomers (e.g., Z-Rf-Ox-CF═CF₂, wherein Z is Br or I, Rf is a substituted or unsubstituted C₁-C₁₂ fluoroalkylene, which may be perfluorinated and may contain one or more ether oxygen atoms, and x is 0 or 1); or a combination thereof, optionally in combination with additional non-fluorinated monomers such as, for example, ethylene or propylene. Specific examples of such fluoropolymers include polyvinylidene fluoride; copolymers of tetrafluoroethylene, hexafluoropropylene and vinylidene fluoride; copolymers of tetrafluoroethylene, hexafluoropropylene, perfluoro(propyl vinyl) ether, and vinylidene fluoride; tetrafluoroethylene-hexafluoropropylene copolymers; tetrafluoroethylene-perfluoro(alkyl vinyl) ether copolymers (e.g., tetrafluoroethylene-perfluoro(propyl vinyl) ether); and combinations thereof.

Useful commercially available thermoplastic fluoropolymers include, for example, those marketed by Dyneon, LLC, Oakdale, Minn., under the trade designations “THV” (e.g., “THV 220”, “THV 400G”, “THV 500G”, “THV 815”, and “THV 610X”), “PVDF”, “PFA”, “HTE”, “ETFE”, and “FEP”; those marketed by Atofina Chemicals, Philadelphia, Pa., under the trade designation “KYNAR” (e.g., “KYNAR 740”); those marketed by Solvay Solexis, Thorofare, N.J., under the trade designations “HYLAR” (e.g., “HYLAR 700”) and “HALAR ECTFE”.

### Fillers

One or more types of conventional fillers are employed with the composite of the present invention. The fillers may be any filler generally recognized by those of skill in the art as being suitable for use in a polymeric matrix. The utilization of fillers provides certain mechanical advantages, such as, for example, increasing modulus, increasing tensile strength, and/or improving the strength-to-density ratios. For purposes of the invention, fillers, as used herein, may mean one or more specific types of filler or a plurality of the same individual filler in a polymeric matrix.

The fillers useful in the inventive composition include all conventional fillers suitable for use in a polymeric matrix. Preferred fillers are glass fiber, talc, silica, calcium carbonate, carbon black, carbon (nano)fibers, alumina silicates, mica, calcium silicates, calcium alumino ferrite (Portland cement), cellulosic materials, nanoparticles, aluminum trihydrate, magnesium hydroxide or ceramic materials. Other fibers of interest include agricultural fibers (plant or animal fiberous materials or byproducts). Cellulosic materials may include natural or wood materials having various aspect ratios, chemical compositions, densities, and physical characteristics. Non-limiting examples of cellulosic materials are wood flour, wood fibers, sawdust, wood shavings, newsprint, paper, flax, hemp, rice hulls, kenaf, jute, sisal, and peanut shells.

Combinations of cellulosic materials, or cellulosic materials with other fillers, may also be used in the composition of the present invention. One embodiment may include glass fiber, talc, silica, calcium carbonate, cellulosic materials, and nanoparticles.

Fillers such as CaCO₃ are often used to reduce the cost and improve the mechanical properties of polymers. Frequently the amount of CaCO₃ that can be added is limited by the relatively poor interfacial adhesion between filler and polymer. This weak interface is the initiation site for cracks that ultimately reduce the strength of the composite.

Talc is generally used in plastic applications to improve dimensional stability, increase stiffness, and decrease cost. This has applicability in the automotive industry, in white goods, packaging, polymer wood composites, and all plastics in general. However, talc and other inorganic fillers do not bind well to most polymeric matrices.

To overcome this limitation, talc is often treated with silanes, stearates, or a maleic anhydride grafted copolymer as coupling agents. These methods tend to improve the processability and mechanical properties of the composite. This invention discloses a class of block copolymers that increase the modulus, i.e. stiffness, of highly-filled polymers at lower loadings than typical coupling agents. The impact of the present invention on physical characteristics is significant enough that the amount of talc can also be lowered.

In another preferred embodiment, the filler is a flame retardant composition. All conventional flame retardant compounds may be employed in the present invention. Flame retardant compounds are those that can be added to a polymeric matrix to render the entire composite less likely to ignite and, if they are ignited, to bum much less efficiently. Non-limiting examples of flame retardant compounds include: chlorinated paraffins; chlorinated alkyl phosphates; aliphatic brominated compounds; aromatic brominated compounds (such as brominated diphenyloxides and brominated diphenylethers); brominated epoxy polymers and oligomers; red phosphorus; halogenated phosphorus; phosphazenes; aryl/alkyl phosphates and phosphonates; phosphorus-containing organics (phosphate esters, P-containing amines, P-containing polyols); hydrated metal compounds (aluminum trihydrate, magnesium hydroxide, calcium aluminate); nitrogen-containing inorganics (ammonium phosphates and polyphosphates, ammonium carbonate); molybdenum compounds; silicone polymers and powder; triazine compounds; melamine compounds (melamine, melamine cyanurates, melamine phosphates); guanidine compounds; metal oxides (antimony trioxide); zinc sulfide; zinc stannate; zinc borates; metal nitrates; organic metal complexes; low melting glasses, nanocomposites (nanoclays and carbon nanotubes); and expandable graphite. One or more of the compounds may be present in the inventive composition in amounts of about 5% by weight to about 70% by weight.

Fluoropolymers, and in particular polytetrafluoroethylene (PTFE), may be incorporated into the polymeric matrix along with conventional flame retardant compositions to enhance melt-processing. It is conventionally recognized that the incorporation of flame retardants into a polymeric matrix may adversely affect the melt-processability of the composition. The incorporation of one or more block copolymers into the polymer matrix containing a flame retardant will enable a greater loading level of flame retardant without adversely affecting the ability to melt process the composition. In one example, the inclusion of the PTFE with one or more block copolymers, as noted herein, and flame retardant fillers enable the melt-processing of the composition. The PTFE is generally included in the melt-processable composition in an amount of about 0.5% by weight to about 5.0% by weight.

### Block Copolymers

The block copolymers are preferably compatible with the polymeric matrix. A compatible mixture refers to a material capable of forming a dispersion in a continuous matrix of a second material, or capable of forming a co-continuous polymer dispersion of both materials. Additionally, the block copolymers are capable of interacting with the fillers. In one sense, and without intending to limit the scope of the present invention, applicants believe that the block copolymers may act as a coupling agent to the fillers in the compatible mixture, as a dispersant in order to consistently distribute the fillers throughout the compatible mixture, or both.

Preferred examples of block copolymers include di-block copolymers, tri-block copolymers, random block copolymers, graft-block copolymers, star-branched copolymers or hyper-branched copolymers. Additionally, block copolymers may have end functional groups.

Block copolymers are generally formed by sequentially polymerizing different monomers. Useful methods for forming block copolymers include, for example, anionic, cationic, coordination, and free radical polymerization methods.

The block copolymers interact with the fillers through functional moieties. Functional blocks typically have one or more polar moieties such as, for example, acids (e.g., —CO₂H, —SO₃H, —PO3H); —OH; —SH; primary, secondary, or tertiary amines; ammonium N-substituted or unsubstituted amides and lactams; N-substituted or unsubstituted thioamides and thiolactams; anhydrides; linear or cyclic ethers and polyethers; isocyanates; cyanates; nitriles; carbamates; ureas; thioureas; heterocyclic amines (e.g., pyridine or imidazole)). Useful monomers that may be used to introduce such groups include, for example, acids (e.g., acrylic acid, methacrylic acid, itaconic acid, maleic acid, fumaric acid, and including methacrylic acid functionality formed via the acid catalyzed deprotection of t-butyl methacrylate monomeric units as described in U.S. Pat. Publ. No. 2004/0024130 (Nelson et al.)); acrylates and methacrylates (e.g., 2-hydroxyethyl acrylate), acrylamide and methacrylamide, N-substituted and N,N-disubstituted acrylamides (e.g., N-t-butylacrylamide, N,N-(dimethylamino)ethylacrylamide, N,N-dimethylacrylamide, N,N-dimethylmethacrylamide), N-ethylacrylamide, N-hydroxyethylacrylamide, N-octylacrylamide, N-t-butylacrylamide, N,N-dimethylacrylamide, N,N-diethylacrylamide, and N-ethyl-N-dihydroxyethylacrylamide), aliphatic amines (e.g., 3-dimethylaminopropyl amine, N,N-dimethylethylenediamine); and heterocyclic monomers (e.g., 2-vinylpyridine, 4-vinylpyridine, 2-(2-aminoethyl)pyridine, 1-(2-aminoethyl)pyrrolidine, 3-aminoquinuclidine, N-vinylpyrrolidone, and N-vinylcaprolactam).

Other suitable blocks typically have one or more hydrophobic moieties such as, for example, aliphatic and aromatic hydrocarbon moieties such as those having at least about 4, 8, 12, or even 18 carbon atoms; fluorinated aliphatic and/or fluorinated aromatic hydrocarbon moieties, such as for example, those having at least about 4, 8, 12, or even 18 carbon atoms; and silicone moieties.

Non-limiting example of useful monomers for introducing such blocks include: hydrocarbon olefins such as ethylene, propylene, isoprene, styrene, and butadiene; cyclic siloxanes such as decamethylcyclopentasiloxane and decamethyltetrasiloxane; fluorinated olefins such as tetrafluoroethylene, hexafluoropropylene, trifluoroethylene, difluoroethylene, and chlorofluoroethylene; nonfluorinated alkyl acrylates and methacrylates such as butyl acrylate, isooctyl methacrylate lauryl acrylate, stearyl acrylate; fluorinated acrylates such as perfluoroalkylsulfonamidoalkyl acrylates and methacrylates having the formula H₂C═C(R₂)C(O)O—X—N(R)SO₂R_{f}, wherein: R_{f}, is —C₆F₁₃, —C₄F₉, or —C₃F₇; R is hydrogen, C₁ to C₁₀ alkyl, or C₆-C₁₀ aryl; and X is a divalent connecting group. Preferred examples include C₄F₉SO₂N(CH₃)C₂H₄OC(O)NH(C₆H₄)CH₂C₆H₄NHC(O)OC₂H₄OC(O)CH═CH₂ or

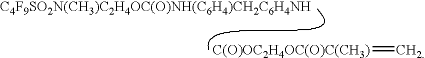

Such monomers may be readily obtained from commercial sources or prepared, for example, according to the procedures in U.S. Pat. No. 6,903,173 (Cernohous et al.), U.S. patent application Ser. No. 10/950932, U.S. patent application Ser. No. 10/950834, and U.S. Provisional Pat. Appl. Ser. No. 60/628335, all of which are herein incorporated by reference in their entirety.

Other non-limiting examples of useful block copolymers having functional moieties include poly(isoprene-block-4-vinylpyridine); poly(isoprene-block-methacrylic acid); poly(isoprene-block-glycidyl methacrylate); poly(isoprene-block-methacrylic anhydride); poly(isoprene-block-(methacrylic anhydride-co-methacrylic acid)); poly(styrene-block-4-vinylpyridine); poly(styrene-block-methacrylamide); poly(styrene-block-glycidyl methacrylate); poly(styrene-block-2-hydroxyethyl methacrylate); poly(styrene-block-isoprene-block-4-vinylpyridine); poly(styrene-block-isoprene-block-glycidyl methacrylate); poly(styrene-block-isoprene-block-methacrylic acid); poly(styrene-block-isoprene-block-(methacrylic anhydride-co-methacrylic acid)); poly(styrene-block-isoprene-block-methacrylic anhydride); poly(MeFBSEMA-block-methacrylic acid) (wherein “MeFBSEMA” refers to 2-(N-methylperfluorobutanesulfonamido)ethyl methacrylate, e.g., as available from 3M Company, Saint Paul, Minn.), poly(MeFBSEMA-block-t-butyl methacrylate), poly(styrene-block-t-butyl methacrylate-block-MeFBSEMA), poly(styrene-block-methacrylic anhydride-block-MeFBSEMA), poly(styrene-block- methacrylic acid-block-MeFBSEMA), poly(styrene-block-(methacrylic anhydride-co-methacrylic acid)-block-MeFBSEMA)), poly(styrene-block-(methacrylic anhydride-co-methacrylic acid-co-MeFBSEMA)), poly(styrene-block-(t-butyl methacrylate-co-MeFBSEMA)), poly(styrene-block-isoprene-block-t-butyl methacrylate-block-MeFBSEMA), poly(styrene-isoprene-block-methacrylic anhydride-block-MeFBSEMA), poly(styrene-isoprene-block-methacrylic acid-block-MeFBSEMA), poly(styrene-block-isoprene-block- (methacrylic anhydride-co-methacrylic acid)-block-MeFBSEMA), poly(styrene-block-isoprene-block-(methacrylic anhydride-co-methacrylic acid-co-MeFBSEMA)), poly(styrene-block-isoprene-block-(t-butyl methacrylate-co-MeFB SEMA)), poly(MeFB SEMA-block-methacrylic anhydride), poly(MeFBSEMA-block-(methacrylic acid-co-methacrylic anhydride)), poly(styrene-block-(t-butyl methacrylate-co-MeFBSEMA)), and hydrogenated forms of poly(butadiene-block-4-vinylpyridine), poly(butadiene-block-methacrylic acid), poly(butadiene-block-N,N-(dimethylamino)ethyl acrylate), poly(butadiene-block-2-diethylaminostyrene), poly(butadiene-block-glycidyl methacrylate), Generally, the block copolymer should be chosen such that at least one block is capable of interacting with the fillers. The choice of remaining blocks of the block copolymer will typically be directed by the nature of any polymeric resin with which the block copolymer will be combined.

The block copolymers may be end-functionalized polymeric materials that can be synthesized by using functional initiators or by end-capping living polymer chains, as conventionally recognized in the art. The end-functionalized polymeric materials of the present invention may comprise a polymer terminated with a functional group on at least one chain end. The polymeric species may be a homopolymers, copolymers, or block copolymers. For those polymers that have multiple chain ends, the functional groups may be the same or different. Non-limiting examples of functional groups include amine, anhydride, alcohol, carboxylic acid, thiol, maleate, silane, and halide. End-functionalization strategies using living polymerization methods known in the art can be utilized to provide these materials.

Any amount of block copolymer may be used, however, typically the block copolymer is included in an amount in a range of up to 10% by weight.

### Coupling Agents

In one aspect, the fillers may be treated with a coupling agent to enhance the interaction between the fillers and the block copolymer. It is desirable to select a coupling agent that matches or provides suitable reactivity with corresponding functional groups of the block copolymer. Non-limiting examples of coupling agents include zirconates, silanes, or titanates. Typical titanate and zirconate coupling agents are known to those skilled in the art and a detailed overview of the uses and selection criteria for these materials can be found in Monte, S. J., Kenrich Petrochemicals, Inc., “Ken-React® Reference Manual—Titanate, Zirconate and Aluminate Coupling Agents”, Third Revised Edition, March, 1995. The coupling agents are included in an amount of about 1% by weight to about 3% by weight.

Suitable silanes are coupled to glass surfaces through condensation reactions to form siloxane linkages with the siliceous filler. This treatment renders the filler more wettable or promotes the adhesion of materials to the glass surface. This provides a mechanism to bring about covalent, ionic or dipole bonding between inorganic fillers and organic matrices. Silane coupling agents are chosen based on the particular functionality desired. For example, an aminosilane glass treatment may be desirable for compounding with a block copolymer containing an anhydride, epoxy or isocyanate group. Alternatively, silane treatments with acidic functionality may require block copolymer selections to possess blocks capable of acid-base interactions, ionic or hydrogen bonding scenarios. Suitable silane coupling strategies are outlined in Silane Coupling Agents: Connecting Across Boundries by Barry Arkles pg 165- 189 Gelest Catalog 3000-A Silanes and Silicones: Gelest Inc. Morrisville, Pa. Those skilled in the art are capable of selecting the appropriate type of coupling agent to match the block copolymer interaction site., The combination of block copolymers with fillers in a polymeric composite may enhance certain mechanical properties of the composite, such as tensile strength, impact resistance, and modulus. In a preferred embodiment, modulus may be improved by 50% or greater over a comparable polymeric composition with a block copolymer of the present invention. Additionally, tensile strength, impact resistance and percent elongation exhibit improvement of at least 10% or greater when compared to a polymeric composition without a block copolymer of the present invention. In another embodiment, percent elongation may be improved as much as 200%. The noted improvements are applicable to both thermoplastic and elastomeric polymeric compositions. Elastomeric compositions containing block copolymers that interact with fillers may also demonstrate improvements in compression set of 10% or greater.

The improved physical characteristics render the composites of the present invention suitable for use in many varied applications. Non-limiting examples include, automotive parts (e.g. o-rings, gaskets, hoses, brake pads, instrument panels, side impact panels, bumpers, and fascia), molded household parts, composite sheets, thermoformed parts, and structural components.

### EXAMPLES

A description of the materials utilized throughout the Examples is included in Table 1 below.

TABLE 1
Materials

| Material | Description |
|---|---|
| P(S-VP) | An AB diblock copolymer, poly[styrene-b-4-vinylpyridine]. |
| | Synthesized using a stirred tubular reactor process as described in |
| | U.S. Pat. No. 6,448,353 and U.S. Pat. No. 6,716,935. Mn = 20 kg/mol, PDI = 1.8, |
| | 95/5 PS/PVP by weight |
| P(S-GMA) | An AB diblock copolymer, poly[styrene-b-Glycidyl Methacrylate]. |
| | Synthesized using a stirred tubular reactor process as described in |
| | U.S. Pat. No. 6,448,353 and U.S. Pat. No. 6,716,935. Mn = 21 kg/mol, PDI = 1.9, |
| | 95/5 PS/GMA by weight |
| P(S-MAn) | An AB diblock copolymer, poly[styrene-b-methacrylic acid-co- |
| | methacrylic anhydride]. Synthesized using a stirred tubular reactor |
| | process as described in U.S. Pat. No. 6,448,353 and U.S. Pat. No. 6,716,935. Mn = 125 kg/mol, |
| | PDI = 1.5, 95/5 PS/MAn by weight |
| Thermoplastic | Flexathene ® TP1300HC available from Equistar, Houston, TX |
| Olefin (TPO) | |
| Talc | Cimpact 710, Non surface-treated ultra-fine talc available from |
| | Luzenac America |
| HDPE | BH-53-35H, a high density polyethylene, commercially available |
| | from Solvay, Houston, TX |
| PA-5933 | A fluoropolymer additive, commercially available from Dyneon |
| | LLC, Oakdale, MN. |
| P(SMA-TBMA) | An AB triblock dipolymer, poly[stearyl methacrylate-b-tert-butyl |
| | methacrylate]. Synthesized using a stirred tubular reactor process |
| | as described in U.S. Pat. No. 6,448,353 and U.S. Pat. No. 6,903,173. Mn = 10 kg/mol, |
| | PDI = 3.53, 70/30 SMA/TBMA by weight. |
| P(TBMA- | An AB triblock dipolymer poly[b-tert-butyl methacrylate-b-2-(N- |
| MeFBSEMA) | methylperfluorobutanesulfonamido)ethyl methacrylate-b- |
| | methacrylic anhydride]. Synthesized using a stirred tubular reactor |
| | process as described in U.S. Pat. No. 6,448,353 and U.S. Pat. No. 6,903,173. Mn = 50 kg/mol, |
| | PDI = 1.8, 70/25 TBMA/MeFBSEMA by weight |
| P(I-S-VP) | ABC triblock copolymer, poly[isoprene-block-styrene-block-4- |
| | vinylpyridine]; synthesized using a stirred tubular reactor, |
| | generally as described in Example 4 of U.S. Pat. No. 6,448,353 |
| | (Nelson et al.), except that styrene was added to the mixture; |
| | Mn = 35 kg/mole; PDI = 2.0; 20/75/5 weight ratio of PI/PS/PVP |
| | isoprene to styrene to 4-vinylpyridine monomeric units. |
| MAPP | Polybond ® 3000, a maleated-polypropylene commercially available |
| | from Crompton Corp., Middlebury, CT. |
| P(I-VP) | An AB diblock copolymer, poly[isoprene-b-(4-vinyl pyridine)]. |
| | Synthesized using a stirred tubular reactor process as described in |
| | U.S. Pat. No. 6,448,353 and U.S. Pat. No. 6,903,173. Mn = 30 Kg/mol x:, PDI = 1.8, |
| | 95/5 PI/VP by weight. |
| Reogard | Reogard 1000 M is a phosphorus nitrogen based, intumescent flame |
| | retardant available from Great Lakes Chemical Corporation, West |
| | Lafayette IN. |
| Exxon 1024E-4 | A 12 MFI Polypropylene (PP) pellet available from ExxonMobil |
| | Chemical Company, Houston, TX. |
| HB9600 | Fortilene ® HB9600 Polypropylene, 12 MFI Polypropylene (PP) |
| | Flake available fromBP Amoco, Naperville, Illinois. |
| Polystyrene | STYRON |
| (PS) | 615APR, available from Dow Chemical Co., Midland, Michigan. |
| Aluminum | Micral 932, commercially available, from J.M. Huber Corporation, |
| trihydrate | Edison, NJ. |
| (ATH) | |
| Calcium | Hubercarb ® G2 GCC, commercially available from J.M. Huber |
| Carbonate | Corporation, Edison, NJ. |
| (CaCO₃) | |
| LDPE | Low density polyethylene LDPE: LD 516.LN, commercially |
| | available from ExxonMobil Chemical Company, Houston, TX. |

Molecular Weight and Polydispersity

Average molecular weight and polydispersity were determined by Gel Permeation Chromatography (GPC) analysis. Approximately 25 mg of a sample were dissolved in 10 milliliters (mL) of THF to form a mixture. The mixture was filtered using a 0.2-micron pore size polytetrafluoroethylene syringe filter. Then, about 150 microliters of the filtered solution were injected into a gel-packed column 25 cm long by 1 cm diameter available under the trade designation “PLGEL-MIXED B” from PolymerLabs, Amherst, Mass., that was part of a GPC system equipped with an autosampler and a pump. The GPC was system 10 operated at room temperature using THF eluent that moved at a flow rate of approximately 0.95 mL/minute. A refractive index detector was used to detect changes in concentration. Number average molecular weight (Mn) and polydispersity index (PDI) calculations were calibrated using narrow polydispersity polystyrene controls ranging in molecular weight from 600 to 6×10⁶ g/mole. The actual calculations were made with software (available under the trade designation “CALIBER” from Polymer Labs, Amherst, Mass.).

1H NMR Spectroscopy

The relative concentration of each block was determined by ¹H Nuclear Magnetic Resonance (1H NMR) spectroscopy analysis. Specimens were dissolved in deuterated chloroform at a concentration of about 10 percent by weight and placed in a 500 MHz NMR Spectrometer available under the trade designation “UNITY 500 MHZ NMR SPECTROMETER” from Varian, Inc., Palo Alto, Calif. Block concentrations were calculated from relative areas of characteristic block component spectra.

Physical Property Testing

Pelletized composite examples containing talc, ATH, and CaCO₃ were injection molded at 180° C. and 70 psi using a Mini-Jector Injection Molder Model 45 (available from Mini-Jector Machinery Corp, Newbury, Ohio).

For all composites, tensile bars were produced for physical property testing and made according to ASTM D1708. The samples were tested on an Instron 5500 R tensile tester (available from Instron Corporation, Canton, Mass.). They were pulled at a rate of 50.8 mm/min in a temperature and humidity controlled room at 21.1° C. and 55% relative humidity. For each sample, 5 specimens were tested and a mean value for the Tensile Modulus was calculated.

General Procedure a for Filled Composites: Continuous Composite Formation

Continuous twin-screw extrusion was carried out using a co-rotating 25-mm twin screw extruder (TSE) with 41:1 L/D, available under the trade designation “COPERION ZSK-25 WORLD LAB EXTRUDER” from Coperion; Ramsey, N.J. Barrel zones for the extruder are 4D (100 mm) in length. The extruder was operated at 392° F. (200° C.) with a screw speed of 300 rpm in all examples. The TSE had a kneading section in barrel zone 4 for incorporating filler and/or block copolymer additives into the molten resin after their addition to the extruder in barrel zone 3. This kneading section was 2.88D in length, incorporating high- and medium-shear intensity forwarding kneading elements for dispersive mixing and a low shear-intensity, reversing kneading element for generating a melt seal and distributive mixing. A small atmospheric vent, ID in length, at the beginning of barrel zone 5 was used to vent any entrapped air or volatiles.

Three downstream mixing sections were incorporated to add shear energy for dispersive and distributive mixing, with an emphasis on distributive mixing to ensure homogeneous distribution of filler particles throughout the composite. A 3.36D mixing section spanned barrel zones 5 and 6, a 2.4D mixing section was employed in barrel zone 7, and 2.88D mixing section spanned barrel zones 8 and 9. In all cases, medium- to low-shear-intensity, forwarding kneading elements and narrow-paddled, low-shear-intensity, reversing kneading elements were selected and employed to yield appropriate dispersive and distributive mixing. A vacuum of 49 torr (6.5 kPa) was pulled on a 2D (50 mm) vacuum vent in barrel zone 9 to remove any remaining volatiles.

In order to achieve thermal homogeneity and additional distributive mixing, a gear-type mixing element, under the trade designation “ZME” available from Coperion was employed downstream of the vacuum vent. The temperature of the melt stream was monitored and recorded over the kneading sections in barrel zones 4 and 6, respectively, by immersion-depth thermocouples positioned just above the tips of the kneading blocks.

Polyolefin resin pellets were fed into the barrel zone 1 feed port utilizing a gravimetric feeder equipped with double spiral screws, available under the trade designation “K-TRON GRAVIMETRIC FEEDER, MODEL KCLKT20” from K-Tron International, Pitman, N. J. Feeding of the filler and block copolymer additive into the barrel zone 1 feed port open was accomplished using a gravimetric feeder equipped with twin auger screws, available under the trade designation “K-TRON GRAVIMETRIC FEEDER, MODEL KCLKT20” from K-Tron International, Pitman, N.J.

The extrudate from the TSE was metered through a 10.3 mL/revolution gear pump available under the trade designation “NORMAG” from Dynisco Extrusion, Hickory, N.C., and extruded through two ¼-inch (0.64-cm) diameter pipes to form a strand. The strand was cooled at 8° C. in a water bath and pelletized using a strand pelletizer available under the trade designation “CONAIR MODEL 304” from Reduction Engineering; Kent, Ohio.

General Procedure B for Filled Composites: Continuous Composite Formation

Continuous twin-screw extrusion was carried out using a co-rotating 25-mm twin screw extruder (TSE) with 41:1 L/D, available under the trade designation “COPERION ZSK-25 WORLD LAB EXTRUDER” from Coperion; Ramsey, N.J. Barrel zones for the extruder are 4D (100 mm) in length. The extruder was operated at 392° F. (200° C.) with a screw speed of 450 rpm in all examples. The TSE had a kneading section in barrel zone 4 for incorporating filler and/or block copolymer additives into the molten resin after their addition to the extruder in barrel zone 3. This kneading section was 2.88D in length, incorporating high- and medium-shear intensity forwarding kneading elements for dispersive mixing and a low shear-intensity, reversing kneading element for generating a melt seal and distributive mixing. A small atmospheric vent, 1D in length, at the beginning of barrel zone 5 was used to vent any entrapped air or volatiles.

Three downstream mixing sections were incorporated to add shear energy for dispersive and distributive mixing, with an emphasis on distributive mixing to ensure homogeneous distribution of filler particles throughout the composite. A 3.36D mixing section spanned barrel zones 5 and 6, a 2.4D mixing section was employed in barrel zone 7, and 2.88D mixing section spanned barrel zones 8 and 9. In all cases, medium- to low-shear-intensity, forwarding kneading elements and narrow-paddled, low-shear-intensity, reversing kneading elements were selected and employed to yield appropriate dispersive and distributive mixing. A vacuum of 49 torr (6.5 kPa) was pulled on a 2D (50 mm) vacuum vent in barrel zone 9 to remove any remaining volatiles.

In order to achieve thermal homogeneity and additional distributive mixing, a gear-type mixing element, under the trade designation “ZME” available from Coperion was employed downstream of the vacuum vent. The temperature of the melt stream was monitored and recorded over the kneading sections in barrel zones 4 and 6, respectively, by immersion-depth thermocouples positioned just above the tips of the kneading blocks.

Polyolefin resin pellets were fed into the barrel zone 1 feed port utilizing a gravimetric feeder equipped with double spiral screws, available under the trade designation “K-TRON GRAVIMETRIC FEEDER, MODEL KCLKT20” from K-Tron International; Pitman, N.J. Feeding of the filler and/or block copolymer additive into the barrel zone 1 feed port open was accomplished using a gravimetric feeder equipped with twin auger screws, available under the trade designation “K-TRON GRAVIMETRIC FEEDER, MODEL KCLKT20” from K-Tron International; Pitman, N.J. The remaining filler was added into barrel zone 5 of the twin-screw extruder by utilizing a gravimetric feeder equipped with twin concave screws, available under the trade designation “K-TRON GRAVIMETRIC FEEDER, MODEL KCLKT20” from K-Tron International; Pitman, New Jersey, to feed a side-feeder, available under the trade designation “TYPE ZSB SIDE-FEEDER” from Coperion; Ramsey, N.J. The filler was split between the two gravimetric feeders in such a way that 60 wt % of the filler was fed into barrel zone 1 and 40wt % was fed into barrel zone 5.

The extrudate from the TSE was metered through a 10.3 mL/revolution gear pump available under the trade designation “NORMAG” from Dynisco Extrusion, Hickory, N.C., and extruded through two ¼-inch (0.64-cm) diameter pipes to form a strand. The strand was cooled at 8° C. in a water bath and pelletized using a strand pelletizer available under the trade designation “CONAIR MODEL 304” from Reduction Engineering; Kent, Ohio.

General Procedure C for Filled Composites: Continuous Composite Formation

Continuous twin-screw extrusion was carried out using a co-rotating 25-mm twin screw extruder (TSE) with 41:1 L/D, available under the trade designation “COPERION ZSK-25 WORLD LAB EXTRUDER” from Coperion; Ramsey, N.J. Barrel zones for the extruder are 4D (100 mm) in length. The extruder was operated at 340° F. (171° C.) with a screw speed of 250 rpm in all examples. The TSE had a kneading section spanning barrel zones 2 and 3 for melting the thermoplastic pellets that are added into the extruder in the barrel zone 1 feed port. This kneading section was 4.32D in length, incorporating high- and medium-shear intensity forwarding kneading elements for dispersive mixing and a low shear-intensity, reversing kneading element for generating a melt seal and some distributive mixing. A small atmospheric vent, 1D in length, at the beginning of barrel zone 5 was used to vent any entrapped air or volatiles. The filler and block copolymer additives were introduced into barrel zone 5 of the extruder through a side-feeder, available under the trade designation “TYPE ZSB SIDE-FEEDER” from Coperion; Ramsey, N.J.

Two downstream mixing sections were incorporated to add shear energy for dispersive and distributive mixing, with an emphasis on distributive mixing to ensure homogeneous distribution of filler particles throughout the composite. A 5.28D mixing section spanned barrel zones 5, 6, and 7, while a 6.24D mixing section spanned barrel zones 7, 8, and 9. In these mixing sections, wide-paddled, high- to medium-shear-intensity, forwarding kneading elements and narrow-paddled, low-shear-intensity, reversing kneading elements were selected and employed to yield appropriate dispersive and distributive mixing. Reverse conveying elements capped both mixing sections in order to generate a melt seal and ensure that the melt stream filled the kneading zones. A vacuum of 49 torr (6.5 kPa) was pulled on a 2D (50 mm) vacuum vent in barrel zone 9 to remove any remaining volatiles. The temperature of the melt stream was monitored and recorded over the kneading sections in barrel zones 6 and 8, respectively, by immersion-depth thermocouples positioned just above the tips of the kneading blocks.

Polyolefin resin pellets were fed into the barrel zone 1 feed port utilizing a gravimetric feeder equipped with double spiral screws, available under the trade designation “K-TRON GRAVIMETRIC FEEDER, MODEL KCLKT20” from K-Tron International; Pitman, N.J. A 6:1 blend of filler to block copolymer additive was fed into the Type ZSB side-feeder using a gravimetric feeder equipped with twin auger screws, available under the trade designation “K-TRON GRAVIMETRIC FEEDER, MODEL KCLKT20” from K-Tron International; Pitman, N.J. For examples generated without the block copolymer additive, this feeder was not utilized. The remaining filler was added into the side-feeder utilizing a gravimetric feeder equipped with twin concave screws, available under the trade designation “K-TRON GRAVIMETRIC FEEDER, MODEL KCLKT20” from K-Tron International; Pitman, N.J.

The extrudate from the TSE was metered through a 10.3 mL/revolution gear pump available under the trade designation “NORMAG” from Dynisco Extrusion, Hickory, N.C., and extruded through two ¼-inch (0.64-cm) diameter pipes to form a strand. The strand was cooled at 8° C. in a water bath and pelletized using a strand pelletizer available under the trade designation “CONAIR MODEL 304” from Reduction Engineering; Kent, Ohio.

Wood Flour-Filled Composites, Continuous Composite Formation

Composite extrusion was carried out using a 19 mm, 15:1 L:D, Haake Rheocord Twin Screw Extruder (available from Haake Inc., Newington, N.H.) equipped with a conical counter-rotating screw and a Accurate open helix dry material feeder (available from Accurate Co. Whitewater, Wis.). The extrusion parameters were controlled and experimental data recorded using a Haake RC 9000 control data computerized software (available for Haake Inc., Newington, N.H.). Materials were extruded through a standard ⅛ inch diameter, 4-strand die (available from Haake Inc., Newington, N.H.).

Wood flour (320 g) was first pre-dried in a vacuum oven for 16 hr at 105° C. (ca. 1 mmHg). HDPE (472 g) was then dry mixed with the wood flour in a plastic bag until a relatively uniform mixture was achieved, and the blend was placed into the dry powder feeder. Additives were dry-blended with the HPDE/wood flour mixture prior to extrusion. The material was fed into the extruder at a rate of 20 g/min (shear rate ˜30 s-1) and was processed using the following temperature profile in each respective zone: 210° C./180° C./180° C. The die was also kept at 180° C. throughout the experiment.

Flame Retardant Formulation Experiments

Composite extrusion was carried out using a 19 mm, 15:1 L:D, Haake Rheocord Twin Screw Extruder (available from Haake Inc., Newington, N.H.) equipped with a conical counter-rotating screw and a Accurate open helix dry material feeder (available from Accurate Co. Whitewater, Wis.). The extrusion parameters were controlled and experimental data recorded using a Haake RC 9000 control data computerized software (available for Haake Inc., Newington, N.H.). Materials were extruded through a standard 0.05 cm diameter, 4-strand die (available from Haake Inc., Newington, N.H.).

Pre-compounding of the P(I-VP) samples was performed using a mixing bowl (Reomix 3000E available form Haake inc.) to compound the P(I-VP)/FR Reogard compounds. Mixing the blend (33 wt % P(I-VP) in Reogard) at a temperature of 225° C. and a rotor speed of 20 rpms for 5 min was sufficient to blend the P(I-VP)/Reogard mixture. During this process, the Reogard was placed in the mixing bowl and allowed to melt first before adding the P(I-VP). Once these melt blends cooled, the large mass was ground to a powder using a lab scale mill (Thomas-Wiley, Lehman Scientific, Red Lion Pa.). PP (1:1 blend, Exxon 1024E-4 pellet; BP Solvay HB9600 Flake) was then dry mixed with the Reogard, with and without pre-compounded P(I-VP)/Reogard (for quantities, see Table 2) in a plastic bag until a relatively uniform mixture was achieved, and the blend was placed into the dry powder feeder.

The material was fed into the extruder at a rate of 17 g/min (shear rate ˜22 s-1) and was processed using the following temperature profile in each respective zone: 190° C./190° C./190° C. The die was also kept at 190° C. throughout the experiment. The extrudate was immediately cooled using a 4∝ long water bath before it was pelletized using a Killian 2 inch pelletizer (Killian Extruders Inc., Cedar Grove, N.J.). Strands of these formulations were also collected for surface roughness analysis.

TABLE 2
Reogard Composite Formulations

| | Loading | | | |
|---|---|---|---|---|
| Formulation Elements: | 0% | 1% | 3% | 5% |
| P(I-VP)/Reogard blend (g) | 0 | 30.3 | 45.5 | 151.5 |
| Reogard(g) | 300 | 279.8 | 269.7 | 199 |
| HB9600 flake PP (g) | 350 | 344.9 | 342.4 | 324.7 |
| 1024E-4 pellet PP (g) | 350 | 344.9 | 342.4 | 324.7 |
| total weight (g) | 1000 | 1000 | 1000 | 1000 |

Polyolefin/Reogard Composite Film Formation Composite extrusion and subsequent film formation was carried out using a 19 mm, 15:1 L:D, Haake Rheocord Twin Screw Extruder (available from Haake Inc., Newington, N.H.) equipped with conical counter-rotating screws. A powder blend of the ingredients based on a mass of 300 g was prepared prior to melt compounding and fed to the extruder via flood-feeding. The composites were extruded through a standard 6 inch film die onto a 12 inch, 3-roll stack (available from Wayne Machine & Die Co., Totowa, N.J.).
Polyolefin/Reogard Film Quality Measurement

Flame retardant composites were analyzed for their ability to be extruded as a film. A rating system from 0 to 10 was developed. In this system, a rating of 0 corresponds to an inability to extrude a film. A rating of 10 corresponds to a smooth film of relatively uniform thickness and an absence of voids. The rating system is essentially linear between these two and is described in Table 3.

TABLE 3
Film Rating for Reogard/PP Samples

| | Film Rating | | | | |
|---|---|---|---|---|---|
| | 0 | 3 | 5 | 8 | 10 |
| Explanation | Film | Extruded film is | Some areas of | Very few | No voids and |
| of rating | unable to | intact, but many | large and/or | voids in film | uniform |
| | be | large and small | small voids | and the | thickness across |
| | extruded | voids exist and the | exist and the | thickness is | web and down |
| | | film thickness | film thickness | somewhat | web |
| | | varies greatly | is not uniform | uniform | |

Surface Roughness Analysis

The definitions for Ra and Rq are taken from ISO4287. Ra is the arithmetic mean of the absolute ordinate values (Z(x)) within a sampling length, where Z(x) is the distance from the best fit line at point x. Rq is the root mean square value of the ordinate values (Z(x)) within a sampling length. For this study, the sampling length was chosen to be 5 mm and the short wavelength cut-off was defined by the image pixel size, 3.6 microns. This sampling length was based on optimizing the imaging conditions for the full set of samples, rather than optimizing for each sample. Additionally, the sampling length was chosen so that it is reasonably consistent with ISO4288 guidelines for Ra's in the range of those observed in the submitted samples. Images were captured by use of a Lecia DC300 digital camera fitted with an Infinivar Video Microscope lens, attached to a Polaroid MP-3 copy stand. The stand has a fluorescent lamp light-box base that was used for back illumination of the samples. The back (or transmitted) light illumination provides a very high contrast image of the edges of the samples.

Reogard/Polyolefin Composite Injection Molding

Injection molding was performed using a Cincinnati Milicron—Fanuc Roboshot 110 (available from Milacron Plastics Technologies, Batavia, Ohio). Tensile testing was subsequently performed on each sample using an Instron 5564 universal materials tester (available from Instron Corporation, Canton, Mass.) as described in ASTM D1708. When making the parts, 15 were injected out of virgin 1024E-4 resin prior to sample injection to ensure that the injection molder and the mold were contaminant free. Subsequently, 15 parts of the sample were generated. This procedure was repeated for each of the samples.

TABLE 4
Injection Molding Parameters of Reogard/PP Composites

| Parameters | Value |
|---|---|
| Injection Speed mm/s | 80 |
| Injection 2nd Speed mm/s | 40 |
| Injection Trans mm | 4 |
| Pack Step kg/cm² | 300 |
| Cool Time s | 30 |
| Step Sec s | 5 |
| Temperature profile ° C. | 200/200/200/200 |
| Back pressure | 50 |
| RPM | 30 |
| Shot Size mm | 41 |
| Decompr. Dist. Mm | 16 |
| Decompr. Veloc. mm/s | 3 |
| Mold Temp. F. | 100 |

### Comparative Examples 1-4

Filled composites were made according to the General Procedure A-C for Filled Composites, Continuous Composite Formation at various filler loadings (10-60%). Procedure A was used for Comparative Example 1, Procedure B for Comparative Example 2, and Procedure C was used for Comparative Examples 3 and 4. The feed rates, resulting compositions, and resulting modulus measurements for Comparative Examples 1-4 are shown in Table 5.

TABLE 5
Comparative Example 1-4
Compositional Analysis and Composite Modulus Results

| Ex- | Resin | | | Filler | | | |
|---|---|---|---|---|---|---|---|
| ample | | | Rate | | | Rate | Modulus |
| ID | ID | wt % | (lb/hr) | ID | wt % | (lb/hr) | (Mpa) |
| 1 | TPO | 90.0 | 18.0 | Talc | 10 | 2.0 | 103.6 |
| 2 | TPO | 50.0 | 10.0 | Talc | 50 | 10.0 | 363.8 |
| 3 | LDPE | 40.0 | 8.0 | ATH | 60 | 12.0 | 74.1 |
| 4 | LDPE | 40.0 | 8.0 | CaCO₃ | 60 | 12.0 | 133.1 |

### Examples 5-23

Filled composites were made according to the General Procedure A-C for Filled Composites, Continuous Composite Formation. General Procedure A applies to Examples 5-8, Procedure B to Examples 9-12, and Procedure C to Examples 13-23. Various block copolymers were utilized as additives at various filler loadings (10-60%). The feed rates, resulting compositions, and resulting modulus measurements are shown in Table 6.

TABLE 6
Example 5-23
Compositional Analysis and Composite Modulus Results

| | Resin | | | Filler | | | Additive | | | |
|---|---|---|---|---|---|---|---|---|---|---|
| Example | | | Rate | | | Rate | | | Rate | Modulus |
| ID | ID | Wt % | (lb/hr) | ID | wt % | (lb/hr) | ID | wt % | (lb/hr) | (Mpa) |
| 5 | TPO | 89.0 | 17.8 | Talc | 10.0 | 2.0 | P(S-VP) | 1.0 | 0.2 | 213.6 |
| 6 | TPO | 85.0 | 17.0 | Talc | 10.0 | 2.0 | P(S-VP) | 5.0 | 1.0 | 226.2 |
| 7 | TPO | 89.0 | 17.8 | Talc | 10.0 | 2.0 | P(S-MAn) | 1.0 | 0.2 | 175.6 |
| 8 | TPO | 85.0 | 17.0 | Talc | 10.0 | 2.0 | P(S-MAn) | 5.0 | 1.0 | 222.1 |
| 9 | TPO | 49.0 | 9.8 | Talc | 50.0 | 10.0 | P(S-VP) | 1.0 | 0.2 | 436.1 |
| 10 | TPO | 45.0 | 9.0 | Talc | 50.0 | 10.0 | P(S-VP) | 5.0 | 1.0 | 847.0 |
| 11 | TPO | 49.0 | 9.8 | Talc | 50.0 | 10.0 | P(S-MAn) | 1.0 | 0.2 | 504.9 |
| 12 | TPO | 45.0 | 9.0 | Talc | 50.0 | 10.0 | P(S-MAn) | 5.0 | 1.0 | 621.4 |
| 13 | LDPE | 39.0 | 7.8 | ATH | 60.0 | 12.0 | P(I-VP) | 1.0 | 0.2 | 275.8 |
| 14 | LDPE | 35.0 | 7.0 | ATH | 60.0 | 12.0 | P(I-VP) | 5.0 | 1.0 | 117.6 |
| 15 | LDPE | 39.0 | 7.8 | ATH | 60.0 | 12.0 | P(I-MAn) | 1.0 | 0.2 | 193.2 |
| 16 | LDPE | 35.0 | 7.0 | ATH | 60.0 | 12.0 | P(I-MAn) | 5.0 | 1.0 | 162.2 |
| 17 | LDPE | 39.0 | 7.8 | ATH | 60.0 | 12.0 | P(S-VP) | 1.0 | 0.2 | 238.7 |
| 18 | LDPE | 39.0 | 7.8 | ATH | 60.0 | 12.0 | P(S-MAn) | 1.0 | 0.2 | 279.8 |
| 19 | LDPE | 35.0 | 5.6 | ATH | 60.0 | 9.6 | P(S-MAn) | 5.0 | 0.8 | 379.8 |
| 20 | LDPE | 39.0 | 7.8 | CaCO₃ | 60.0 | 12.0 | P(S-VP) | 1.0 | 0.2 | 191.2 |
| 21 | LDPE | 35.0 | 7.0 | CaCO₃ | 60.0 | 12.0 | P(S-VP) | 5.0 | 1.0 | 148.3 |
| 22 | LDPE | 39.0 | 7.8 | CaCO₃ | 60.0 | 12.0 | P(S-MAn) | 1.0 | 0.2 | 140.7 |
| 23 | LDPE | 35.0 | 7.0 | CaCO₃ | 60.0 | 12.0 | P(S-MAn) | 5.0 | 1.0 | 261.7 |

As evident by the tensile modulus data, the addition of as little as 1% of a block compolymer can have a major impact on the mechanical properties of the TPO/Talc composite. Addition of 1% or 5% of P(S-VP) or P(S-MAn) to the 10% talc-filled composite can substantially impact the modulus, increasing it by nearly 100% or more (Comparative Example 1 versus Examples 5-8).

Upon addition of 50% talc to the TPO, an increase in the modulus is observed relative to the unfilled polymer. However, the addition of 1% or 5% of P(S-VP) or P(S-MAn) to the 50% talc-filled composite significantly increases the modulus over the talc-filled TPOs (Cf. Example 2 with Examples 9-12). Similar trends were found in LDPE composites containing ATH (Cf. Example 3 with Examples 13-19) and CaCO3 (Cf. Example 4 with Examples 20-23).

### Comparative Example 24 and Examples 25-26 Reogard/PP Filled Composites

Reogard/PP Filled composites were made according to the general procedure for Flame Retardant Formulation Experiments. Physical property testing and surface roughness results are shown in Table 7.

TABLE 7
Surface Roughness Analysis Summary

| | | | | | | Max Tensile | | |
|---|---|---|---|---|---|---|---|---|
| Example | PP | Reogard | P(I-VP) | Average | Average | Strength | Yield Stress | % |
| ID | wt % | wt % | wt % | Ra | Rq | (mPa) | (mPa) | Elongation |
| 24 | 70.0 | 30.0 | 0.0 | 50.2 | 61.3 | 34.8 | 34.8 | 200 |
| 25 | 69.0 | 30.0 | 1.0 | 17.3 | 21.7 | 37.0 | 37.0 | 300 |
| 26 | 65.0 | 30.0 | 5.0 | 7.1 | 9.4 | NA | NA | 450 |

As is evident from the surface roughness analysis of these strands (Table 7), a drastic improvement in surface quality is achieved by inclusion of as little as 1% of the P(I-VP) block copolymer (Cf. Example 24 with 25 and 26 ).

To gauge the effect of P(I-VP) inclusion on the flame retardant formulation's physical properties, the various formulations were injection molded to produce samples suitable for physical property testing. Inclusion of as little as 1% P(I-VP) improved maximum tensile stress and yield stress, while 3% inclusion of P(I-VP) improves elongation at break over the control in this case (Cf. Example 24 with 25 and 26).

During injection molding, it was observed that PP/Reogard parts made from samples containing P(I-VP) (Example 25) were easier to process and cycle, versus the control PP/Reogard material (Example 24), due to their ease of release from the mold and sprue. The control sample adhered to the mold, at the closest point to the injection inlet and specifically in the sprue. (Example 24) However, none of the samples with P(I-VP) displayed this phenomena and were easy to eject and cycle (Example 25).

### Comparative Examples 27- 30 Polyolefin/Reogard Composite Film Formation

Reogard/PP Composites were formed according to the Polyolefin/Reogard Composite Film Formation procedure described previously. Films were generated and evaluated according to the guidelines provided in the Polyolefin/Reogard Film Quality Measurement. Table 8 describes the contents of these composites, including the description of other comparative additives explored.

TABLE 8
Reogard/PP Composite Formulations and Film Quality Analysis

| | | Extruder | | | | | | Resultant |
|---|---|---|---|---|---|---|---|---|
| Example | Extruder | Temp | PP | Reogard | | Additive | Rate | Film |
| ID | rpm | (° C.) | wt % | wt % | Additive | wt % | (ft/min) | Quality |
| 27 | 65 | 200 | 100.0 | 0.0 | — | 0.0 | 10.0 | 10 |
| 28 | 65 | 200 | 70.0 | 30.0 | — | 0.0 | 2.4 | 0 |
| 29 | 65 | 200 | 69.0 | 30.0 | PS | 1.0 | 2.4 | 1 |
| 30 | 65 | 200 | 69.0 | 30.0 | MAPP | 1.0 | 2.4 | 4 |

PP films containing no Reogard (Example 27) displayed excellent quality in comparison to PP/Reogard composites containing 30% Reogard (Example 28), 30% Reogard/1% PS (Example 29) and 30% Reogard/1% MAPP (Example 30).

### Examples 32-36 Polypropylene/Reogard Composite Film Formation

Reogard/PP Composites were formed according to the Polyolefin/Reogard Composite Film Formation procedure described previously. Films were generated and evaluated according to the guidelines provided in the Polyolefin/Reogard Film Quality Measurement. Table 9 describes the contents of these composites, which here includes an examination of several block copolymers as additives.

TABLE 9
Reogard/PP Composite Formulations and Film Quality Analysis

| | | Extruder | | | | | | Resultant |
|---|---|---|---|---|---|---|---|---|
| Sample | Extruder | Temp | PP | Reogard | | Additive | Rate | Film |
| ID | rpm | (° C.) | wt % | wt % | Additive | wt % | (ft/min) | Quality |
| 32 | 65 | 200 | 69.0 | 30.0 | P(SMA- | 1.0 | 2.4 | 6 |
| | | | | | TBMA) | | | |
| 33 | 65 | 200 | 69.0 | 30.0 | P(TBMA- | 1.0 | 3.5 | 7 |
| | | | | | MeFBSEMA) | | | |
| 34 | 65 | 200 | 69.0 | 30.0 | P(S-MAn) | 1.0 | 2.4 | 7 |
| 35 | 65 | 200 | 69.0 | 30.0 | P(S-VP) | 1.0 | 6.8 | 8 |
| 36 | 65 | 200 | 69.0 | 30.0 | P(I-S-VP) | 1.0 | 4.2 | 9 |

Clearly the inclusion of the block copolymers aid in providing enhanced melt strength and film quality as shown in Table 9. In particular, note the activity of P(I-S-VP) in improving film quality vs PP/Rheogard Composites which were compounded in its absence (Cf. Example 28 with Example 36)

### Comparative Example 37 and Examples 38-39 Reogard/HDPE Composites Formation

Reogard/HDPE Composites were formed according to the Flame Retardant Formulation Experiments procedure described previously. Strands of these composites were evaluated according to the guidelines provided in the Surface Roughness Analysis description above. Table 10 describes the contents of these composites, which here includes an examination of P(I-VP), with and without the presence of a processing aid, PA-5933.

TABLE 10
Reogard/PP Composite Formulations and Film Quality Analysis

| Example | Extruder | Extruder | HDPE | Reogard | PA-5933 | P(I-VP) | | |
|---|---|---|---|---|---|---|---|---|
| ID | rpm | Temp (° C.) | wt % | wt % | wt % | wt % | Ra | Rq |
| 37 | 65 | 200 | 70.0 | 30.0 | 0.0 | 0.0 | 56 | 70.2 |
| 38 | 65 | 200 | 69.0 | 30.0 | 0.0 | 1.0 | 23.5 | 30.6 |
| 39 | 65 | 200 | 69.0 | 30.0 | 0.5 | 0.5 | 5.9 | 7.5 |

In comparing Examples 37 and 38, the presence of the P(I-VP) material improves the surface quality of these composite strands as measured by surface profilometry. Further improvements are found by using combinations of block copolymer with PA-5933 (Cf. Example 38 with Example 39).

### Comparative Example 40 and Example 41 Wood Polymer Composite Formation

Wood flour filled composites were made according to the general procedure for Wood Flour Filled Composites, Continuous Composite Formation. P(S-GMA) was utilized and compared to a sample containing only wood flour. The feed rates, compositions, and resulting tensile measurements are shown in Table 11.

TABLE 11
Example 40-41 Composite Formulation and Tensile Strength Results

| | | | | | Tensile |
|---|---|---|---|---|---|
| Example | Resin | Wood flour | Additive | Additive | Strength |
| ID | wt % | wt % | ID | wt % | MPA |
| 40 | 60.0 | 40.0 | — | 0.0 | 39.1 |
| 41 | 59.0 | 40.0 | PS-GMA | 1.0 | 44.0 |

In comparing Examples 40 and 41, the use of the block copolymer in these wood flour composites improves tensile strength.

What is claimed is:

1. A composition comprising:
(a) a polymeric matrix;
(b) a plurality of fillers; and
(c) a block copolymer wherein at least one segment of the block copolymer interacts with the fillers.

2. A composition according to claim 1, wherein the block copolymer is included in an amount of up to 10% by weight.

3. A composition according to claim 1, wherein the composition exhibits an increased modulus of about 25% or greater over a composition having just the polymer matrix and filler.

4. A composition according to claim 1, wherein the block copolymer is selected from one or more of a di-block copolymer, a tri-block copolymer, a random block copolymer, a graft-block copolymer, a star-branched block copolymer, an end-functionalized copolymer, and a hyper-branched block copolymer.

5. A composition according to claim 1, wherein the polymeric matrix is selected from one or more of polyamides, polyimides, polyethers, polyurethanes, polyolefins, polystyrenes, polyesters, polycarbonates, polyketones, polyureas, polyvinyl resins, polyacrylates, fluorinated polymers, and polymethylacrylates.

6. A composition according to claim 1, wherein the at least one segment of the block copolymer is compatible with the polymeric matrix.

7. A composition comprising:
(a) a plurality of fillers having surfaces;
(b) a block copolymer wherein at least one segment of the block copolymer is capable of interacting with the fillers upon application in a polymeric matrix.

8. A composition according to claim 1, wherein the fillers include a flame retardant compound.

9. A composition according to claim 8, wherein the block copolymer is included in an amount of up to 10% by weight.

10. A composition according to claim 8, further comprising one or more of an antioxidant, a light stabilizer, an antiblocking agent, a plasticizer, a microsphere, and a pigment.

11. A composition according to claim 8, wherein the block copolymer is selected from one or more of a di-block copolymer, a tri-block copolymer, a random block copolymer, a graft-block copolymer, a star-branched block copolymer, an end-functionalized copolymer, and a hyper-branched block copolymer.

12. A composition according to claim 8, wherein the polymeric matrix is selected from one or more of a polyamide, a polyimide, a polyether, a polyurethane, a polyolefin, a polystyrene, a polyester, a polycarbonate, a polyketone, a polyurea, a polyvinyl resin, a polyacrylate, a fluorinated polymer, and a polymethylacrylates.

13. A composition comprising:
(a) a flame retardant compound; and
(b) a block copolymer wherein at least one segment of the block copolymer is capable of interacting with the flame retardant compound upon application in a polymeric matrix.

14. A composition according to claim 13, further comprising a fluorinated polymer.

15. A composition according to claim 14, wherein the fluorinated polymer is polytetrafluorethylene.

16. A composition according to claim 13, further comprising a polymeric matrix, wherein the polymeric matrix is extruded into a film.

17. A method comprising melt-processing the composition of claim 1.
